(19) United States
(12) Patent Application Publication
(10) Pub. No.: US 2007/0139955 A1
(43) Pub. Date: Jun. 21, 2007

(54) LIGHTING OR SIGNALLING DEVICE WITH A LIGHT GUIDE, FOR A MOTOR VEHICLE

(75) Inventors: Vincent Godbillon, Bobigny Cedex (FR); Vincent Jeanmichel, Bobigny Cedex (FR); Henning Vogt, Bobigny Cedex (FR)

Correspondence Address: MATTHEW R. JENKINS, ESQ., 2310 FAR HILLS BUILDING, DAYTON, OH, 45419, US

(73) Assignee: VALEO VISION, Bobigny Cedex (FR)

(21) Appl. No.: 11/612,035

(22) Filed: Dec. 18, 2006

(30) Foreign Application Priority Data
Dec. 20, 2005 (FR) 0512980

(51) Int. Cl. F21S 4/00

(52) U.S. Cl. 362/583

(57) ABSTRACT

A lighting and/or signalling device for a motor vehicle, comprising a light guide adapted to be supplied with light through an input face situated at one of its ends, whereby to perform a first photometric function, a light source adapted to supply the light guide with light through its input face whereby to perform the first function, and at least one dioptric or reflective element which is disposed close to the input face and/or output face of the light guide, and adapted to take out a portion of the light emitted by the light source, whereby to perform a second photometric function.

### FIELD OF THE INVENTION

The present invention relates to a lighting or signalling device for a motor vehicle which includes at least one light guide adapted to produce diffusion of the light over at least part of its length. The invention also relates to a vehicle including such a lighting or signalling device.

### BACKGROUND OF THE INVENTION

In the field of lighting and signalling for motor vehicles, it is becoming more and more common to make use of light guides. A light guide is, in very simple terms, an element which is elongated transparently and which is generally in the form of a cylinder. Close to one of the ends of the light guide, called the input face of the guide, there is, or are, disposed a light guide or several light guides, for example a light guide of small size of the light emitting diode type: the light rays emitted by this source are propagated by total reflection within the length of the light guide towards its opposite end, which is called the terminal face of the guide. A portion of the light rays being propagated within the guide will leave it via the face which is called the front face (or output face) of the guide, due to the presence of reflecting elements which are disposed on the face called the rear face (or reflecting face) of the guide, opposite the last mentioned face. These reflective elements consist for example of prisms. The guide thus emits light over its whole length. It has the advantage that it can take very varied geometrical forms, it can be rectilinear or shaped as as arc of a circle, and it can bring an illuminating surface even into zones of a headlight or rear light unit of the vehicle which are barely accessible. It therefore has a great influence on styling of the headlight or rear light unit.

Light guides are used in particular in signalling or indicating functions, for example as marker lights.

The object of the invention is to apply novel types of improved light guide, and in particular those having an increased number of functions.

### DISCUSSION OF THE INVENTION

First of all, according to the invention there is provided a lighting and/or signalling device for a motor vehicle, comprising:
a light guide adapted to be supplied with light through an input face situated at one of its ends, whereby to perform a first photometric function,
a light source adapted to supply the said light guide with light through its input face whereby to perform the said first function, and
at least one dioptric or reflective element which is disposed close to the input face and/or output face of the light guide, and adapted to take out a portion of the light emitted by the light source, whereby to perform a second photometric function.

The light guide is an element which is adapted to emit light over the greater part of its length, and is not a simple conveyor of light as a fibre optic would be.

The dioptric element is preferably not a light guide itself. Similarly the reflective element preferably does not cover the whole cross section of the light guide or that of its input face.

The invention therefore consists in making use of the known association between the light source and the light guide, enabling for example a function of the marker light type to be obtained, and also enabling an optical element to be added to it but not any additional light source, thereby obtaining a further function, which may for example be of the side marker light type. Obtaining two functions with one light source enables a very compact optical system to be obtained, which is always a point of great advantage in the automotive field. In addition, the use of a common light source or a common cluster of light sources, for the purpose of ensuring two functions, is of advantage for reasons of economy of electrical consumption. Moreover, the extraction of some of the light in this way can be done without any detriment to the performance of the conventional function of the light guide.

In this connection, light emitting diodes are often used for supplying light to light guides, but these diodes emit in a half plane, whereas it is desired to inject light into the guide, the input face of which is only a few square millimetres. One is therefore forced to collimate, in order to channel the light emitted by the diode in the best way towards the input face of the guide, by adapting the form of the input face of the guide so that, for example, it surrounds the emitting surface of the diode in the best way. However, a little of the light emitted by the diode always remains, and this is lost and not used by the guide. The idea of the invention is therefore, not to improve the design of the input face of the guide even more, but, on the contrary, to take advantage of this situation in order to exploit the lost part of the light, and thereby to achieve a second optical function, with the aid of a dioptric element, which may simply be a lens or a reflective element such as a mirror. It is thus possible to obtain two photometric functions, and therefore two light beams with different characteristics (such as their dominant directions, distribution grids, and so on), with notable economy of means.

It should be noted that the light source of the diode type is preferably placed in immediate proximity to the input face of the light guide: it directly emits light towards the input face. However, as an alternative, it can also be disposed further away, with the light emitted by the light source being able to be channelled or guided up to the input face of the light guide by optical means, which may for example be of the fibre optic type.

Various embodiments of the invention are possible, such as those which are described below. These embodiments are either alternatives to each other, or they may be combined.

According to a first embodiment, the dioptric element directly intercepts a portion of the light emitted by the light source. In this case it is a matter either of recuperating some light which would otherwise never have reached the input face of the light guide, or of taking out a fraction of the light which would otherwise have reached the input face of the light guide, so that this taking out of light does not affect the lighting function performed by the light guide.

According to a second embodiment, the dioptric element intercepts a portion of light which is emitted by the light source and which is then reflected by the input face towards the outside of the light guide. In this connection, when the light rays reach the input face of the light guide, the greater part of the latter enters into the guide and is propagated within it, but another portion is reflected out of the guide in accordance with the Fresnel laws. By way of example, for guides made in transparent materials with a refractive index of about 1.5, the portion of the rays that is reflected to the outside is about 4% when the light rays arrive at right angles to the input face. This proportion increases with the inclination of the ray with respect to the input face. It is commonly sought to configure the input face in such a way as to minimise this reflection, but here, in the context of the invention, it will more often be sought to control it precisely or even to amplify it. Thus, the input face of the light guide may be chosen in the form of a surface which is at least partly curved, and which is preferably convex or bowed, or which is at least partly inclined with respect to the longitudinal axis of the light guide.

According to a third embodiment, a portion of the light emitted by the light source is reflected by a prismatic element integrated with the light guide close to its input face, and then leaves the guide by passing through the dioptric element. The dioptric element is either integrated with the light guide, or not. The rays recuperated by the dioptric element are then issued, in the case in point, from multiple reflections.

Preferably, the dioptric element may be integrated with the light guide. This configuration enables the two components to be moulded as one piece, and to ensure perfect relative positioning.

It can also be integrated into an intermediate screen, or be integrated into the cover lens of a headlight or a rear light unit.

In order to perform the second photometric function with the same light source, two things can in fact be distinguished: it is first of all necessary to take out the quantity of light which is sufficient, and to give it the direction and distribution desired. According to the different embodiments which will be the subject of detailed examples to be given later herein, when the light is recuperated by the dioptric element, it already has, for example, the desired dominant direction, the dioptric element then performing only the function of concentrating or assembling the light rays. However, the light intercepted by the dioptric element may also, when it reaches that element, not have the desired direction: it is then necessary that the dioptric element shall also be adapted to divert at least a portion of the light rays passing through it.

The dioptric element may be a lens with an output face formed with prisms, which may or may not be progressive. These prisms may themselves carry optical elements such as ribs or rings. Its input face may also be formed with Fresnel rings.

Preferably, the first function envisaged, that is to say the function obtained with the light guide, is a signalling or indicating function of the tail marker light or tail light type, while the second function envisaged, that is to say the function obtained with the aid of the dioptric element, is a signalling function of the side marker light type.

The dioptric or reflective element may also be located close to the output face of the light guide: the light for the purposes of the second photometric function is then taken out not at the upstream end of the light guide, but at the downstream end of the latter, being taken out of the quantity of light that reaches the downstream end of the light guide.

The invention also provides the motor vehicle having headlights, or rear lights, that include the device set forth above.

The invention will be described in detail with the aid of examples of embodiments which are not limiting and which are illustrated by the following Figures of the drawings.

### BRIEF DESCRIPTION OF THE DRAWINGS

FIGS. 1 and 2 show cross sections of light guides in the prior art, which are designed to be incorporated in motor vehicle rear light units.

FIGS. 3a, 3b and 3c show three versions of cross sections of a light guide in a first embodiment of the invention.

FIGS. 4a, 4b and 4c show three relative configurations of light guide and dioptric element in accordance with the invention.

FIGS. 5a and 5b show two forms of dioptric element according to the invention.

FIG. 6 shows a configuration in which the light guide and dioptric lens are joined together.

FIG. 7 shows a configuration in which the dioptric lens is part of the cover glass of a rear light.

FIG. 8 shows a three-dimensional view of the guide, the light source and the lens in a modified version of the invention.

FIGS. 9a and 9b correspond to a further modified version of the invention, in which a prism is incorporated in the entry of the light guide.

FIG. 10 corresponds to a three-dimensional view of the version shown in FIGS. 9a and 9b.

FIGS. 11a and 11b correspond to a further modified version of the invention, which is an alternative to that shown in FIGS. 9a and 9b.

FIGS. 12a and 12b correspond to yet another modified version, in which the dioptric element is disposed close to the output face, and not the entry, of the light guide.

### DESCRIPTION OF PREFERRED EMBODIMENTS OF THE INVENTION

All of the Figures are very diagrammatic, and do not necessarily have any regard to scale, this being to facilitate reading of the drawings. It will be clearly understood that in all the following Figures of the drawings, the light guide is shown indifferently in a curved form or in a straight line form, and that the invention is applicable to all forms of light guide.

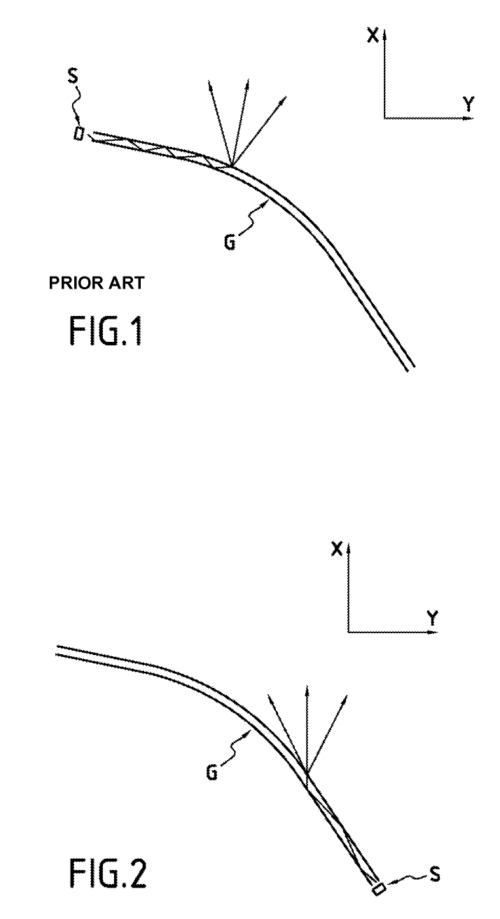

FIG. 1 shows a cross section of a light guide G in the prior art, which is designed to perform a tail light function in a vehicle rear light cluster. The guide is fed by a light emitting diode S which is disposed close to one of its ends, on the inside of the vehicle. The direction X indicated in FIG. 1 corresponds to the dominant direction of the light emitted by the guide in order to ensure the tail light function. The direction Y on the other hand shows the dominant direction which is sought for the side marker function of the same light, which may be obtained with another light source and other optical elements.

FIG. 2 shows a further configuration of a light guide in the prior art in which, this time, the diode S is disposed at the end of the guide which lies in the return portion of the rear light unit. The X and Y directions have the same meaning as in FIG. 1.

It is possible to optimise the light guide in such a way that it transmits light along the X axis, but the side marker light function, which demands a dominant orientation at right angles to the tail light function, makes it necessary to provide separate dedicated optical means.

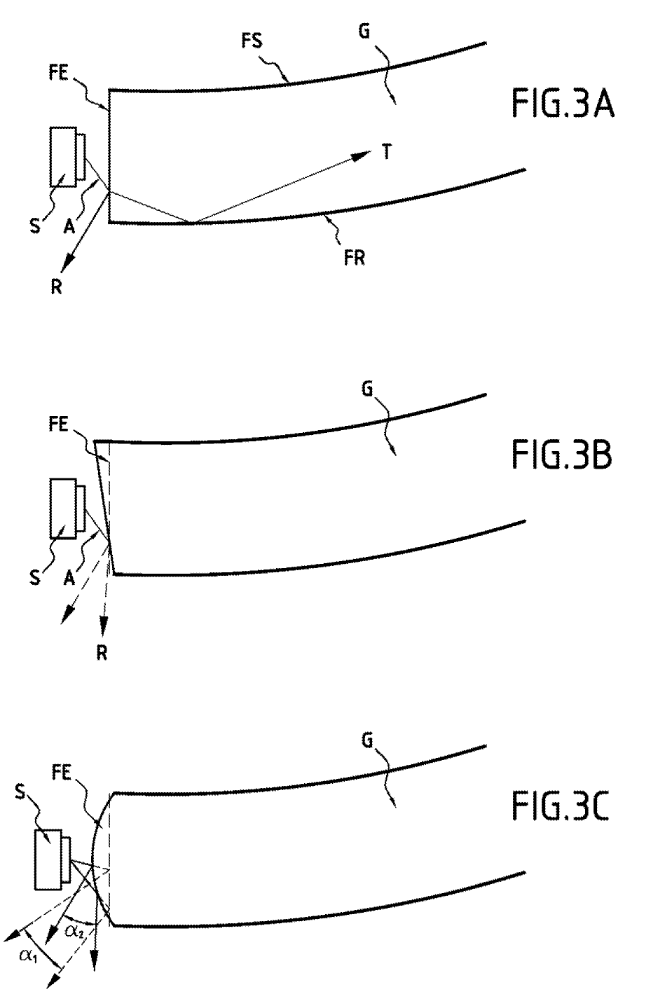

FIGS. 3a, 3b and 3c correspond to a first embodiment of the invention: the light guide is adapted to perform the marker light function, and some light emitted by the source is recuperated after being reflected on the input face of the guide G, in order to perform a side marker function.

In this version, the light guide G has a circular cross section; it should be clearly understood that it may, in other versions, have an elliptical, or oval or square etc. cross section.

In this particular version, the light guide G is made of transparent polymer, of polycarbonate (or polymethylmetacrylate, PMMA), being preferably of crystal quality.

The light guide has a so-called input face FE at one of its ends, facing which there is disposed a light emitting diode S, and a terminal face FT, which constitutes the end opposite to the first mentioned end and which does not have a light source. It is optionally possible to provide a second light source at each of the two ends of the guide. The guide also has two main faces which are oriented along its length and which consist of:
a first face FS which constitutes an output face for light rays propagated in the light guide G; this output face FS may be smooth and continuous or it may include ribs; and
a second face FR opposed to the first face FS, constituting a reflecting face of the light guide G and being accordingly provided with reflective elements, in particular prisms.

For more details as to the geometry of the reflective and output faces of such a light guide, reference may be made to French patents FR 04 06375 and FR 04 06376.

FIG. 3a shows the path of a light ray incident on the input face FE of the light guide G: it comprises an absorbed portion A at the surface of the light guide, a portion T which is transmitted into the guide and which will be propagated in the latter, and a portion R which will be reflected. It is this reflected light portion which will enable a light flux sufficient to obtain the side marker light function to be obtained. It is also possible to increase the percentage of light reflected by the input face FE and/or to modify its major orientation by modifying its geometry, in the following ways:
in FIG. 3a the input face is straight; it is disposed at right angles to the longitudinal axis of the light guide G, this being the simplest configuration, or
in FIG. 3b, the input face FE has been modified, it being flat but inclined with respect to the longitudinal axis of the light guide: the solid arrow indicates the general orientation of the light which is reflected by the input face of the light guide, for comparison with the arrow in broken lines which corresponds to the orientation obtained with the configuration according to FIG. 3a,
in FIG. 3c, the input face FE has been modified in such a way that it is convex or bowed. Using the same conventions, it will be seen that in the previous Figure, this particular form enables the orientation of the reflected light to be modified. It is possible to accentuate and/or adapt the degree of convexity of this face, to modulate it in an appropriate way in order to adjust the said orientation to the best advantage according to requirements. It will also be seen that the angular amplitude of the light transmitted with a flat input face (alpha 1) is smaller than that which is obtained with a bowed face (alpha 2).

From FIGS. 3a, 3b and 3c it is possible to see how light could be recuperated in order to give the side marker light function, but the distribution of the reflected light beam does not generally cover the complete photometric grid which is necessary in order to obtain that function. This is why it is appropriate to provide optical means in order to modify the distribution of the beam. The choice of this optical means depends on several parameters: the form of the input face, which, as has been seen, is able to modify the general orientation and/or the aperture of the reflected beam, or the distance and relative disposition of the diode with respect to the said input face (which will have an influence on the aperture of the reflected beam). In addition, the light emitted by the light guide close to the input face can also contribute to obtaining the side marker light function: the light reflected by the input face will then only complete the photometry which is obtained by the light guide.

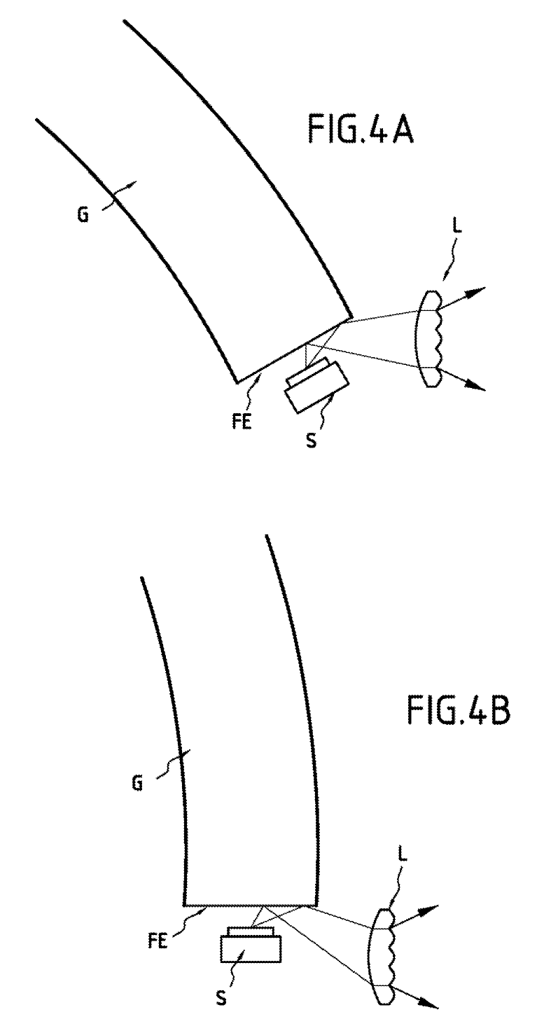

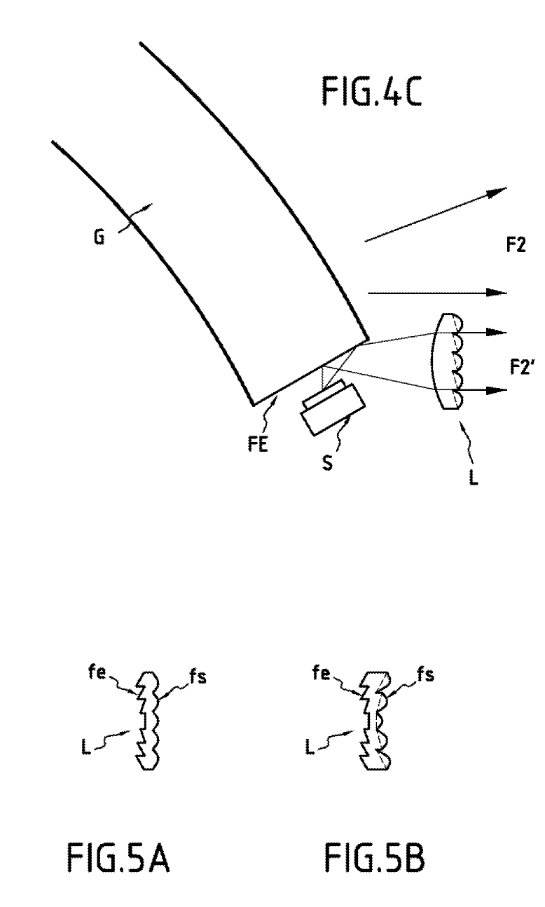

It is possible to add, to these choices in terms of the form of the light guide and light source, the presence of a dioptric element L. FIGS. 4a, 4b and 4c show a lens L which is placed close to the input face FE of the light guide and which is arranged to intercept the light reflected by the input face of the light guide.

In the case of FIG. 4a, the lens has a convex input face, and an output face with optical elements (for example ribs or rings), deposited on a flat surface.

In the case of FIG. 4b, the lens has a convex input face and an output face with optical elements (for example ribs or rings) deposited on prisms (which are indicated in broken lines), which enable the orientation of the distribution of the beam passing through the lens to be modified.

It will be noted that the rays leaving the lens have substantially the same general orientation and the same distribution both in the case shown in FIG. 4a and that shown in FIG. 4b, and that the orientation and distribution of the rays incident on the lens are different in the two cases: this is made possible by adding prisms on the output face of the lens in the case of FIG. 4b.

In the case of FIG. 4c, part of the photometry of the side marker light function is provided through the upstream or input end portion F2 of the guide, with the rays that pass through the lens L completing the photometry of F2 with the further output F2′. In that case, motifs on the output face of the lens L are preferably disposed in the opposite direction from that shown in FIG. 4b.

FIGS. 5a and 5b show further versions of the lens L, as follows:
in FIG. 5a the lens has a Fresnel type input face, so as to reduce the thickness of the lens, and
in FIG. 5b the lens has, in addition, on its output face fs, prisms which are progressively inclined from the centre towards the periphery of the lens.

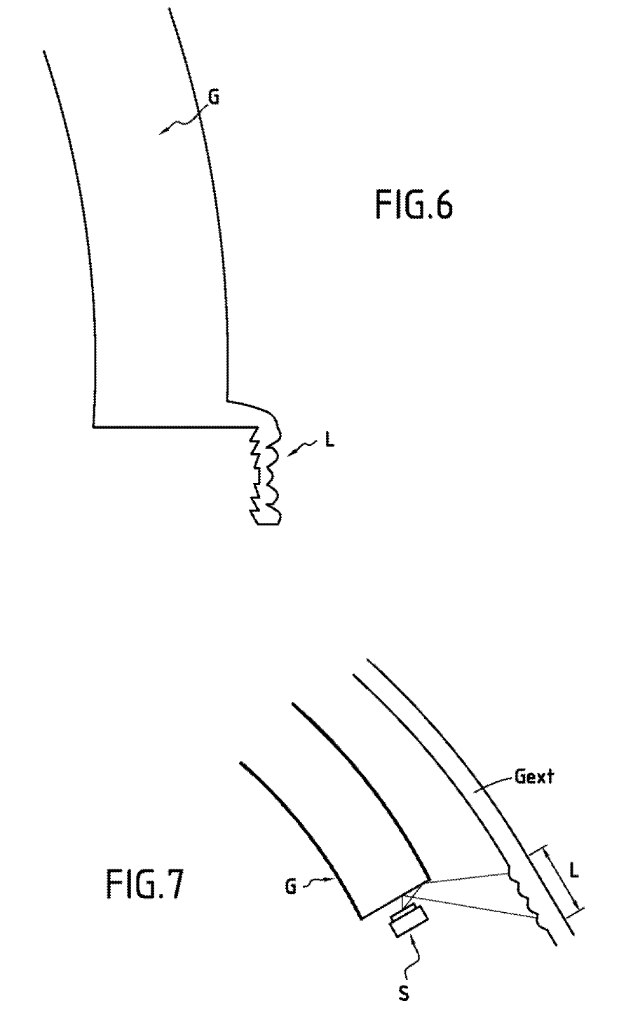

FIG. 6 is a variant of FIGS. 4a to 4c described above: in order to guarantee correct positioning of the lens L with respect to the guide, these two elements are joined, to form one piece. They may be moulded in a single step. It is also possible to mould the lens on the guide. This configuration also enables the number of components in the rear light unit to be reduced.

FIG. 7 is yet another version: this time, the lens L is an integral part of the outer cover lens Gext of the rear light unit of the vehicle.

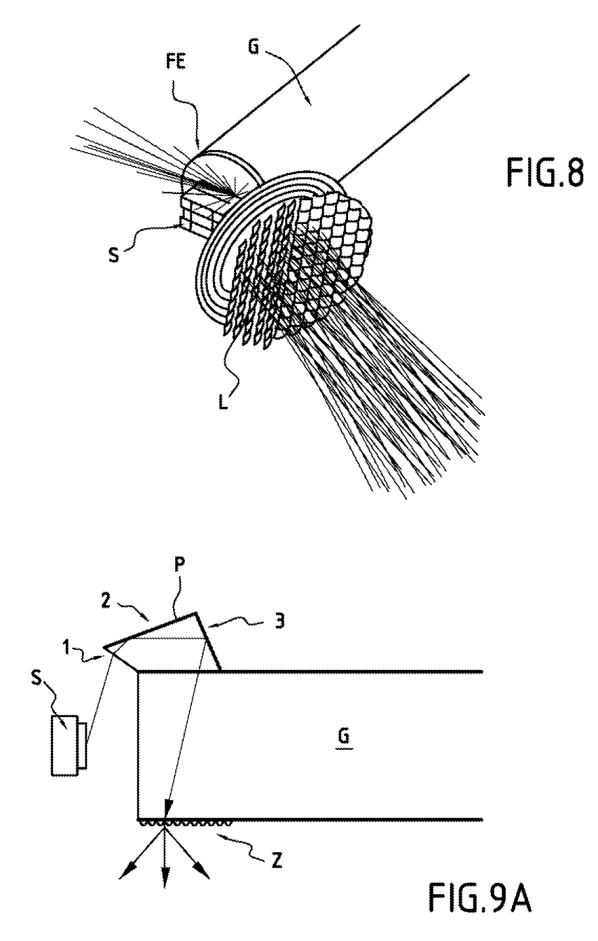

FIG. 8 shows in three dimensions the guide, the lens and the diode shown in FIG. 5b. The beam of light reflected by the input face of the light guide, and then redirected towards the lens L, can be seen here.

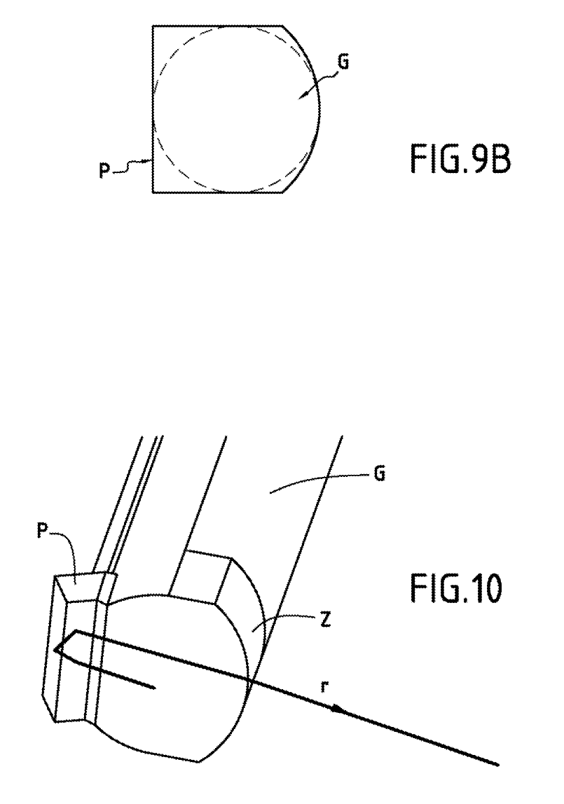

FIGS. 9a and 9b correspond to a further embodiment of the invention. In this case, the light recuperated in order to perform the side marker light function comes from a prismatic element P with three faces on the side of the reflecting face FR of the light guide G. FIG. 9a shows the path of a ray within the triple faced prism P: the rays transmitted from the diode S enter through the first face 1 of the prism P, being refracted. They are reflected by total reflection on the two following faces 2 and 3 of the prism. Finally they pass through the light guide within its width and leave it through a zone Z, on the output face FS of the light guide, close to the input face FE. This zone Z is preferably provided with optical motifs which are disposed in such a way that the emerging beam has the required photometric distribution to constitute a side marker light, like the dioptric element of the foregoing versions. The optical motifs may consist of ribs or rings or prisms, or rings or ribs disposed on prisms. Alternatively these optical motifs could be disposed on a separate optical element or on the cover lens of the light unit.

The carrier of these motifs can depart from the general form of the cross section of the light guide: FIG. 9b shows the transverse cross section of the guide at the level of the prism P. The broken line represents the cross section of the light guide outside the zone extending to the level of the prism, that is to say a round cross section. The carrier surface of the prism is shown in full lines.

FIG. 10 is a three-dimensional representation of the version shown in FIGS. 9a and 9b. The path of a ray r produced by the light source S and reflected on the prism P is shown here.

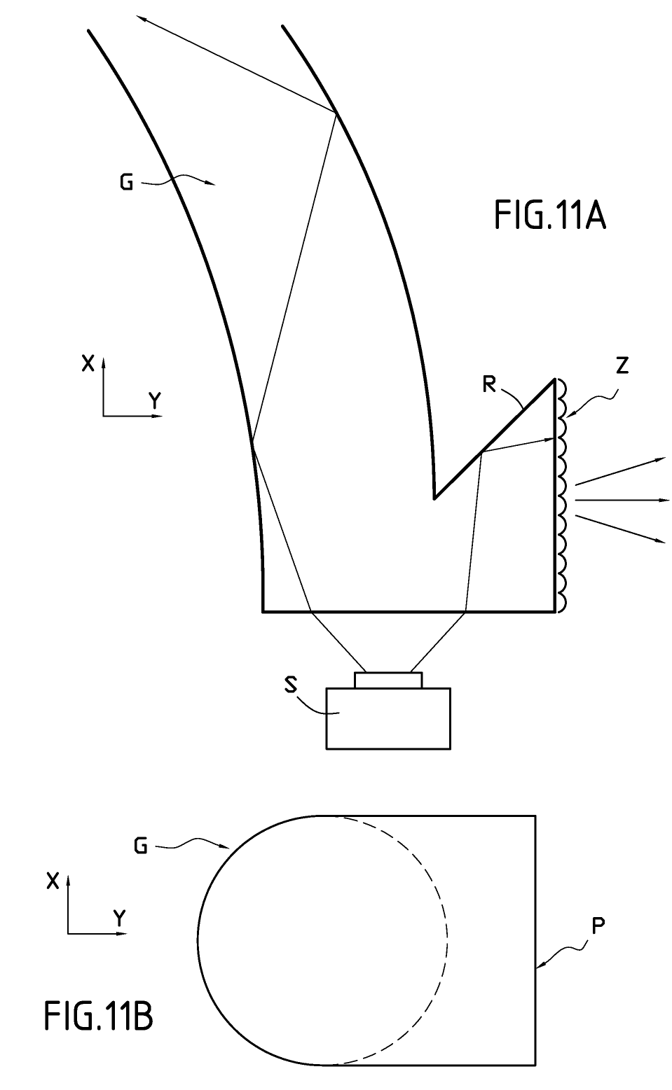

FIGS. 11a and 11b show a modified version of the light guide described with reference to FIGS. 9a and 9b above: here, the “cube” deflector is replaced by an enlarged section of the input face of the light guide as shown in FIG. 11b, which represents a section of the light guide at the level of its input face: as shown in FIG. 11a, a first portion of the light emitted by the light source enters the light guide and follows its path within the guide in order to perform the main photometric function, while the other portion also enters through the input face, but is then reflected through the face R and leaves the guide via the surface Z. Reflection on the face R is able to be obtained by total or partial reflection. Alternatively it can be obtained by metalising the surface R. In this way the second photometric function is obtained by virtue of the light leaving from the surface Z.

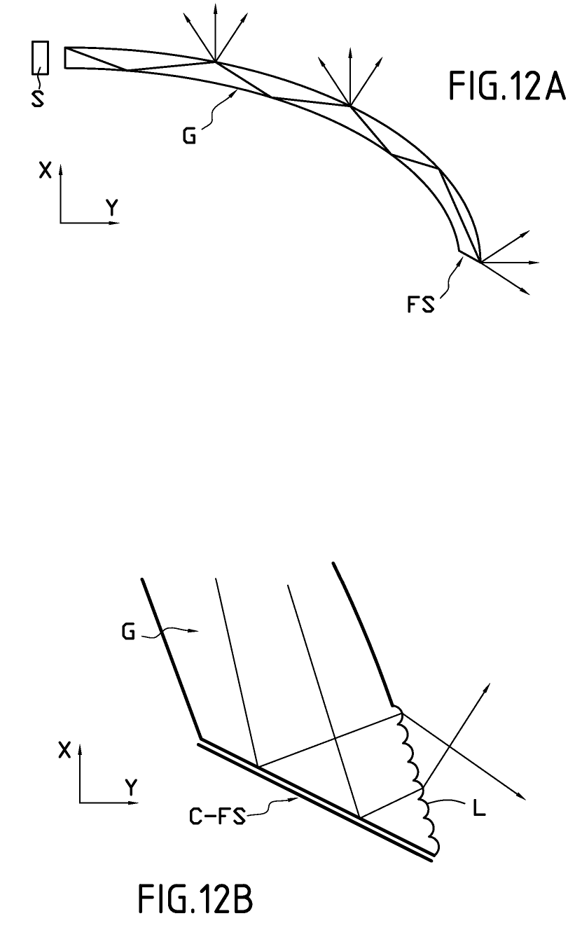

FIGS. 12a and 12b propose a further variant, in which, this time, some light is taken out in order to perform a second function close to the output face FS of the light guide: all or part of the light reaching the output face is reflected on the said face (by total or partial reflection, or by metalising the said face, for example). This reflected light reaches the zone L which is provided with dioptric elements of the prism type, which divert it in an appropriate way so that it will carry out the required second photometric function. When the dioptric or reflective element according to the invention is placed at the level of, or close to, the output face and not the input face of the guide, it can take out substantially all of the light which arrives at that end, whereas if it is close to the input face, it can only take out a portion so that the main function shall be assured.

In conclusion, the invention enables two functions to be obtained, in particular two signalling functions which are achieved with very different photometries and relative orientations, and with only one light source. This is of even greater advantage in the context of vehicle rear lights having large side return or wing portions. The added optical element may be integrated in various ways: for example, it may be joined to the light guide, or to the cover lens, or to a screen, or to a mounting base, or it may even be integrated with the light guide itself.

1. A lighting and/or signalling device for a motor vehicle, comprising:
a light guide adapted to be supplied with light through an input face situated at one of its ends, whereby to perform a first photometric function,
a light source adapted to supply said light guide with light through its input face whereby to perform said first photometric function, and
at least one dioptric or reflective element which is disposed close to the input face and/or output face of the light guide, and adapted to take out a portion of the light emitted by the light source, whereby to perform a second photometric function.

2. The device according to claim 1, wherein said dioptric or reflective element directly intercepts a portion of the light emitted by the light source.

3. The device according to claim 1, wherein said dioptric or reflective element intercepts a portion of light which is emitted by the light source and which is then reflected by the input face towards the outside of the light guide.

4. The device according to claim 1, wherein a portion of the light emitted by the light source is reflected by a prismatic element integrated with the light guide close to its input face and then leaves the guide by passing through the dioptric element, said dioptric or reflective element being either integrated with the light guide, or not.

5. The device according to claim 1, wherein said dioptric or reflective element is integrated with the light guide.

6. The device according to claim 1, wherein the dioptric or reflective element is integrated with an intermediate screen or with an outer lens of the device.

7. The device according to claim 1, wherein said input face of said guide is a surface which is at least partly curved, and in particular is convex, or at least partly inclined.

8. The device according to claim 1, wherein said dioptric or reflective element is adapted to divert at least a portion of the light rays passing through it.

9. The device according to claim 1, wherein said dioptric or reflective element is a lens with an output face having prisms, progressive or not progressive, with the prisms themselves optionally carrying optical elements such as ribs or rings.

10. The device according to claim 1, wherein said dioptric element is a lens with an input face having Fresnel rings.

11. The device according to claim 1, wherein said dioptric or reflective element is disposed close to the output face of the optical guide, in such a way as to take out all or part of the light reaching the said output face.

12. The device according to claim 1, wherein said first photometric function is a marker light function in a tail light.

13. The device according to claim 1, wherein said second photometric function is a side marker light function.

14. The device according to claim 1, wherein said light source is a light emitting diode or a cluster of light emitting diodes.

15. A lighting and/or signalling device for a motor vehicle, comprising:
a light guide adapted to be supplied with light through an input face for performing a first photometric function;
a light source adapted to supply said light guide with light through its input face to perform said first photometric function; and
at least one dioptric or reflective element adapted to direct or deviate at least a portion of the light emitted by the light source to perform a second photometric function.

16. The device according to claim 15, wherein said dioptric or reflective element directly intercepts a portion of the light emitted by the light source.

17. The device according to claim 15, wherein said dioptric or reflective element intercepts a portion of light which is emitted by the light source and which is then reflected by the input face towards an outside of the light guide.

18. The device according to claim 15, wherein a portion of the light emitted by the light source is reflected by a prismatic element integrated with the light guide close to its input face and then leaves the guide by passing through the dioptric element, said dioptric or reflective element being either integrated with the light guide, or not.

19. The device according to claim 15, wherein said first photometric function is a marker light function in a tail light.

20. The device according to claim 15, wherein said second photometric function is a side marker light function.

21. The device according to claim 15, wherein said light source is a light emitting diode or a cluster of light emitting diodes.

22. A method for generating a tail light and side marker light comprising the steps of:
providing a light guide for directing light from a light source in a first direction to provide the tail light; and
adapting said light guide so that said light guide may cause at least a portion of said light to be directed or diverting in a second direction that is different from said first direction in order to provide said side marker light.

23. The method as recited in claim 22 wherein said method further comprises the step of:
situating at least one dioptric or reflective element in a path between at least one of an entry end or an exit end or of said light guide and said light source.

24. The method as recited in claim 23 wherein said method comprises the step of:
integrally molding said at least one dioptric or reflective element with said light guide.

25. The method as recited in claim 22, wherein said second direction is generally perpendicular or oblique relative to said first direction.
